(19) United States
(12) Patent Application Publication
(10) Pub. No.: US 2026/0149922 A1
(43) Pub. Date: May 28, 2026

(54) ACOUSTIC FEEDBACK PROCESSING SYSTEM AND METHOD

(71) Applicant: INTELLIGO TECHNOLOGY INC., Zhubei City (TW)

(72) Inventors: Chun-Ming HUANG, Zhubei City (TW); Yu-An LU, Zhubei City (TW); Yao-Chun LIU, Zhubei City (TW); Chen-Chu HSU, Zhubei City (TW); Tsung-Liang CHEN, Zhubei City (TW)

(21) Appl. No.: 19/047,894

(22) Filed: Feb. 7, 2025

(30) Foreign Application Priority Data
Nov. 25, 2024 (TW) 113145308

(51) Int. Cl. H04R 3/02; H04R 25/00

(52) U.S. Cl. CPC H04R 3/02; H04R 25/453; H04R 2460/07

(57) ABSTRACT

An acoustic feedback processing system including a first signal feature extraction circuit, a first encoding circuit, an acoustic feedback detection circuit and an acoustic feedback elimination circuit is disclosed. The first signal feature extraction circuit is configured to extract a signal feature from a first sound signal. The first encoding circuit is coupled to the first signal feature extraction circuit and configured to receive the first sound signal, the signal feature and a conference identification code and generate an encoded sound signal accordingly. The acoustic feedback detection circuit is coupled to the first encoding circuit and configured to receive the encoded sound signal and a second sound signal respectively and determine whether acoustic feedback phenomenon exists. The acoustic feedback elimination circuit is coupled to the acoustic feedback detection circuit and configured to perform an acoustic feedback elimination process through a neural network in the case of acoustic feedback phenomenon.

### TECHNICAL FIELD

The invention relates to acoustic feedback, and more particularly to an acoustic feedback processing system and an acoustic feedback processing method.

### BACKGROUND

In workplaces, it is common for two or more computer users to participate in the same online conference in the same conference room, thus generating feedback sound. When the feedback sound is too loud, it may even cause a howling phenomenon. In particular, the feedback sound from two computers does not have an appropriate reference signal to help suppress it, so it is more difficult to suppress than a hearing aid whose feedback sound comes from the same device. As a result, the main sound is distorted, making the product ineffective.

Therefore, the above-mentioned problems encountered by the prior art still need to be solved.

### SUMMARY

In view of this, an acoustic feedback processing system and an acoustic feedback processing method are proposed in the invention to effectively solve the above-mentioned problems in the prior art.

An embodiment of the invention is an acoustic feedback processing system. In this embodiment, the acoustic feedback processing system includes a first signal feature extraction circuit, a first encoding circuit, an acoustic feedback detection circuit and an acoustic feedback elimination circuit. The first signal feature extraction circuit is configured to extract a signal feature from a first sound signal. The first encoding circuit is coupled to the first signal feature extraction circuit and configured to receive the first sound signal, the signal feature and a conference identification code and generate an encoded sound signal accordingly. The acoustic feedback detection circuit is coupled to the first encoding circuit and configured to receive the encoded sound signal and a second sound signal respectively and determine whether acoustic feedback phenomenon exists. The acoustic feedback elimination circuit is coupled to the acoustic feedback detection circuit and configured to perform an acoustic feedback elimination process through a neural network in the case of acoustic feedback phenomenon.

In an embodiment, when the acoustic feedback detection circuit detects that the conference identification code and the signal feature of the second sound signal and the encoded sound signal are the same, the acoustic feedback detection circuit determines that the acoustic feedback phenomenon exists, and the acoustic feedback elimination circuit performs the acoustic feedback elimination process.

In an embodiment, when the acoustic feedback detection circuit detects that the conference identification code and the signal feature of the second sound signal and the encoded sound signal are different, the acoustic feedback detection circuit determines that the acoustic feedback phenomenon does not exist, and the acoustic feedback elimination circuit does not operate.

In an embodiment, the acoustic feedback processing system is applied to a first information processing device and the first information processing device includes a first receiving unit and a first output unit. The first receiving unit is coupled to the acoustic feedback detection circuit and configured to receive the second sound signal and transmit the second sound signal to the acoustic feedback detection circuit. The first output unit is coupled to the first signal feature extraction circuit, the first encoding circuit and the acoustic feedback elimination circuit respectively and configured to output the first sound signal.

In an embodiment, the acoustic feedback processing system is further applied to a second information processing device and the second information processing device includes a second receiving unit and a second output unit. The second receiving unit is configured to receive the first sound signal outputted by the first output unit and the second output unit is configured to output the second sound signal to the first receiving unit.

In an embodiment, the acoustic feedback processing system further includes a second signal feature extraction circuit and a second encoding circuit. The second signal feature extraction circuit is coupled to the second receiving unit and configured to extract the signal feature from the first sound signal. The second encoding circuit is coupled to the second receiving unit, the second output unit and the second signal feature extraction circuit respectively and configured to receive the first sound signal, the signal feature and the conference identification code respectively and generate the second sound signal accordingly to the second output unit.

In an embodiment, the first encoding circuit also receives a first position information of the first information processing device and generates the encoded sound signal having the first position information accordingly; the second encoding circuit also receives a second position information of the second information processing device and generates the second sound signal having the second position information accordingly.

In an embodiment, when the acoustic feedback detection circuit detects that the conference identification code and the signal feature of the second sound signal and the encoded sound signal are the same and knows that the first information processing device and the second information processing device are located in the same space, the acoustic feedback detection circuit determines that the acoustic feedback phenomenon exists, and the acoustic feedback elimination circuit performs the acoustic feedback elimination process.

In an embodiment, the first output unit is a network transmission processing element, the second output unit is a speaker, the first receiving unit is a microphone, and the second receiving unit is a network reception processing element.

In an embodiment, the first sound signal outputted by the first output unit is transmitted to the second receiving unit through a network.

In an embodiment, when the acoustic feedback elimination circuit performs the acoustic feedback elimination process, the acoustic feedback elimination circuit determines a main target signal and an acoustic feedback signal in the second sound signal through the neural network, and performs automatic alignment of delays between the main target signal and the acoustic feedback signal and performs suppression and elimination of the acoustic feedback signal to completely retain the main target signal.

Another embodiment of the invention is an acoustic feedback processing method. In this embodiment, the acoustic feedback processing method includes steps of: (a) a first information processing device outputting a first sound signal and extracting a signal feature from the first sound signal; (b) the first information processing device generating an encoded sound signal according to the first sound signal, the signal feature and a conference identification code; (c) the first information processing device determining whether acoustic feedback phenomenon exists according to a second sound signal and the encoded sound signal it receives; and (d) if a determination result of step (c) is yes, the first information processing device performing an acoustic feedback elimination process through a neural network.

In an embodiment, the step (c) is to detect whether the conference identification code and the signal feature of the second sound signal and the encoded sound signal are the same to determine whether the acoustic feedback phenomenon exists.

In an embodiment, if the step (c) detects that the conference identification code and the signal feature of the second sound signal and the encoded sound signal are the same, it is determined that the acoustic feedback phenomenon exists; if the step (c) detects that the conference identification code and the signal feature of the second sound signal and the encoded sound signal are different, it is determined that the acoustic feedback phenomenon does not exist.

In an embodiment, the acoustic feedback processing method further includes steps of: (e) a second information processing device receiving the first sound signal outputted by the first information processing device and extracting the signal feature from the first sound signal; and (f) the second information processing device generating the second sound signal according to the first sound signal, the signal feature and the conference identification code and outputting the second sound signal.

In an embodiment, the step (b) also receives a first position information of the first information processing device and generates the encoded sound signal having the first position information accordingly; the step (f) also receives a second position information of the second information processing device and generates the second sound signal having the second position information accordingly.

In an embodiment, the acoustic feedback processing method further includes steps of: when the conference identification code and the signal feature of the second sound signal and the encoded sound signal are the same and it is known that the first information processing device and the second information processing device are located in the same space according to the first location information and the second location information, the step (c) determines that the acoustic feedback phenomenon exists, and the step (d) performs the acoustic feedback elimination process.

In an embodiment, the first sound signal outputted by the first output unit is transmitted to the second information processing device through a network.

In an embodiment, when the first information processing device performs the acoustic feedback elimination process, the acoustic feedback processing method also includes steps of: determining a main target signal and an acoustic feedback signal in the second sound signal through the neural network; and performing automatic alignment of delays between the main target signal and the acoustic feedback signal and performing suppression and elimination of the acoustic feedback signal to completely retain the main target signal.

Compared with the prior art, the acoustic feedback processing system and the acoustic feedback processing method of the application can achieve the following effects:
(1) when multiple computer users in the same space participate in the same online conference at the same time, there is no need to turn off the microphone and speakers to prevent howling caused by acoustic feedback;
(2) when multiple players in the same space use the hands-free mode of mobile phones to play games together, all players can still chat without hindrance even if the game sound effects on their mobile phones are turned on at the same time; and
(3) when the user wears the hearing aid, it can prevent the whistling phenomenon caused by acoustic feedback to avoid damage to the user's hearing.

### BRIEF DESCRIPTION OF THE DRAWINGS

FIG. 1 illustrates a schematic diagram of the acoustic feedback processing system in the first preferred embodiment of the invention.

FIG. 2 illustrates a schematic diagram of the acoustic feedback processing system in the second preferred embodiment of the invention.

FIG. 3 illustrates a flowchart of the acoustic feedback processing method in the third preferred embodiment of the invention.

### DETAILED DESCRIPTION

A first preferred embodiment of the invention is an acoustic feedback processing system. In this embodiment, the acoustic feedback processing system is applied to a single information processing device, such as a notebook computer, a tablet computer, a mobile phone, etc., but not limited to this.

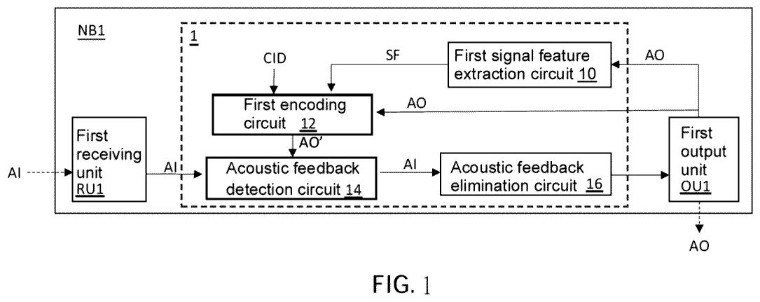

Please refer to FIG. 1, which is a schematic diagram of the acoustic feedback processing system in this embodiment. As shown in FIG. 1, the acoustic feedback processing system 1 is applied to a first information processing device NB1. The first information processing device NB1 includes a first receiving unit RU1 and a first output unit OU1. The first receiving unit RU1 can be a microphone and the first output unit OU1 can be a transmission processing element. The acoustic feedback processing system 1 includes a first signal feature extraction circuit 10, a first encoding circuit 12, an acoustic feedback detection circuit 14 and an acoustic feedback elimination circuit 16.

The first receiving unit RU1 is coupled to the acoustic feedback detection circuit 14. The first output unit OU1 is coupled to the first signal feature extraction circuit 10, the first encoding circuit 12 and the acoustic feedback elimination circuit 16 respectively. The first signal feature extraction circuit 10 is coupled to the first output unit OU1 and the first encoding circuit 12 respectively. The first encoding circuit 12 is coupled to the first output unit OU1, the first signal feature extraction circuit 10 and the acoustic feedback detection circuit 14 respectively. The acoustic feedback detection circuit 14 is coupled to the first receiving unit RU1, the first encoding circuit 12 and the acoustic feedback elimination circuit 16 respectively. The acoustic feedback elimination circuit 16 is coupled to the acoustic feedback detection circuit 14 and the first output unit OU1 respectively.

The first output unit OU1 is configured to output a first sound signal AO. The first signal feature extraction circuit 10 is configured to receive the first sound signal AO outputted by the first output unit OU1, extract a signal feature SF from the first sound signal AO, and then transmit the signal feature SF to the first encoding circuit 12. The first encoding circuit 12 is configured to receive the first sound signal AO outputted by the first output unit OU1, the signal feature SF transmitted by the first signal feature extraction circuit 10, and a conference identification code CID of an online conference attended by the first information processing device NB1 respectively, and generate an encoded sound signal AO′ to the acoustic feedback detection circuit 14 according to the first sound signal AO, the signal feature SF and the conference identification code CID.

The first receiving unit RU1 is configured to receive a second sound signal AI and transmit the second sound signal AI to the acoustic feedback detection circuit 14. The acoustic feedback detection circuit 14 is configured to receive the encoded sound signal AO′ and the second sound signal AI respectively, and determine whether an acoustic feedback phenomenon exists accordingly. When the acoustic feedback detection circuit 14 determines that the acoustic feedback phenomenon exists, the acoustic feedback elimination circuit 16 is configured to perform an acoustic feedback elimination process through a neural network.

In practical applications, the acoustic feedback detection circuit 14 can determine whether the acoustic feedback phenomenon exists by detecting whether the conference identification code CID and the signal feature SF of the second sound signal AI and the encoded sound signal AO′ are the same. When the acoustic feedback detection circuit 14 detects that the conference identification code CID and the signal feature SF of the second sound signal AI and the encoded sound signal AO′ are the same, the acoustic feedback detection circuit 14 determines that the acoustic feedback phenomenon exists, and the acoustic feedback elimination circuit 16 performs the acoustic feedback elimination process through the neural network. When the acoustic feedback detection circuit 14 detects that the conference identification code CID and the signal feature SF of the second sound signal AI and the encoded sound signal AO′ are different, the acoustic feedback detection circuit 14 determines that the acoustic feedback phenomenon does not exist, and the acoustic feedback elimination circuit 16 does not operate at this time.

In addition, when the acoustic feedback elimination circuit 16 performs the acoustic feedback elimination process, the acoustic feedback elimination circuit 16 can determine a main target signal and an acoustic feedback signal in the second sound signal AI through the neural network, and automatically align delays between the main target signal and the acoustic feedback signal and suppress and eliminate the acoustic feedback signal, so that the main target signal can be completely retained, but not limited to this.

A second preferred embodiment of the invention is also an acoustic feedback processing system. In this embodiment, the acoustic feedback processing system is applied to two information processing devices, such as two laptops, tablet computers, mobile phones, etc., but not limited to this.

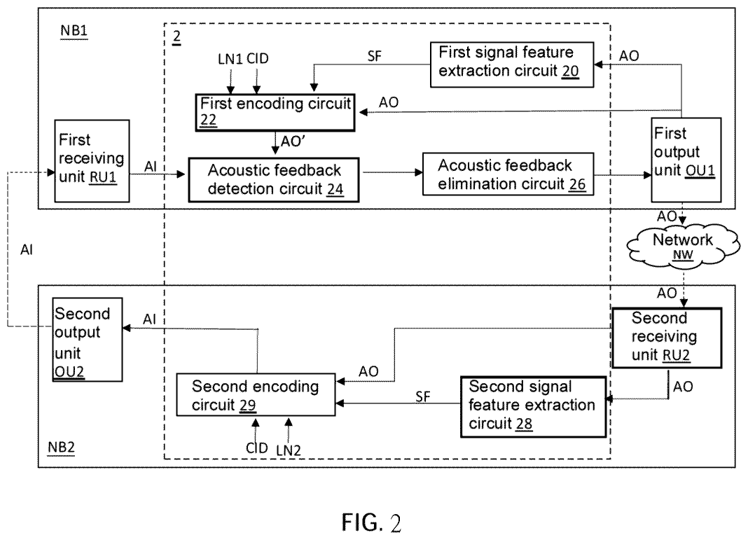

Please refer to FIG. 2, which is a schematic diagram of the acoustic feedback processing system in this embodiment. As shown in FIG. 2, the acoustic feedback processing system 2 is applied to a first information processing device NB1 and a second information processing device NB2. The first information processing device NB1 and the second information processing device NB2 are connected through a network NW. The first information processing device NB1 includes a first receiving unit RU1 and a first output unit OU1. The second information processing device NB2 includes a second receiving unit RU2 and a second output unit OU2. The first receiving unit RU1 can be a microphone and the first output unit OU1 can be a network transmission processing element. The second receiving unit RU2 can be a network receiving processing element and the second output unit OU2 can be a speaker.

The acoustic feedback processing system 2 includes a first signal feature extraction circuit 20, a first encoding circuit 22, an acoustic feedback detection circuit 24, an acoustic feedback elimination circuit 26, a second signal feature extraction circuit 28 and a second encoding circuit 29. Among them, the first signal feature extraction circuit 20, the first encoding circuit 22, the acoustic feedback detection circuit 24 and the acoustic feedback elimination circuit 26 are applied to the first information processing device NB1, and the second signal feature extraction circuit 28 and the second encoding circuit 29 are applied to the second information processing device NB2.

The first receiving unit RU1 is coupled to the acoustic feedback detection circuit 24. The first output unit OU1 is coupled to the first signal feature extraction circuit 20, the first encoding circuit 22 and the acoustic feedback elimination circuit 26 respectively. The first output unit OU1 is connected to the second receiving unit RU2 through the network NW. The first signal feature extraction circuit 20 is coupled to the first output unit OU1 and the first encoding circuit 22 respectively. The first encoding circuit 22 is coupled to the first output unit OU1, the first signal feature extraction circuit 20 and the acoustic feedback detection circuit 24 respectively. The acoustic feedback detection circuit 24 is coupled to the first receiving unit RU1, the first encoding circuit 22 and the acoustic feedback elimination circuit 26 respectively. The acoustic feedback elimination circuit 26 is coupled to the acoustic feedback detection circuit 24 and the first output unit OU1 respectively. The second receiving unit RU2 is coupled to the second signal feature extraction circuit 28 and the second encoding circuit 29 respectively. The second receiving unit RU2 is connected to the first output unit OU1 through the network NW. The second output unit OU2 is coupled to the second encoding circuit 29. The second signal feature extraction circuit 28 is coupled to the second receiving unit RU2 and the second encoding circuit 29 respectively. The second encoding circuit 29 is coupled to the second receiving unit RU2, the second output unit OU2 and the second signal feature extraction circuit 28 respectively.

The first output unit OU1 of the first information processing device NB1 is configured to output the first sound signal AO and transmit the first sound signal AO to the second receiving unit RU2 of the second information processing device NB2 through the network NW. The first signal feature extraction circuit 20 is configured to receive the first sound signal AO outputted by the first output unit OU1 and extract the signal feature SF from the first sound signal AO and transmit the signal feature SF to the first encoding circuit 22. The first encoding circuit 22 is configured to receive the first sound signal AO outputted by the first output unit OU1, the signal feature SF transmitted by the first signal feature extraction circuit 10, and the conference identification code CID of an online conference attended by the first information processing device NB1 respectively, and generate an encoded sound signal AO′ to the acoustic feedback detection circuit 24 according to the first sound signal AO, the signal feature SF and the conference identification code CID.

The first receiving unit RU1 of the first information processing device NB1 is configured to receive the second sound signal AI outputted by the second output unit OU2 of the second information processing device NB2 and transmit the second sound signal AI to the acoustic feedback detection circuit 24. The acoustic feedback detection circuit 24 is configured to receive the encoded sound signal AO′ and the second sound signal AI respectively and determine whether an acoustic feedback phenomenon exists accordingly. When the acoustic feedback detection circuit 24 determines that the acoustic feedback phenomenon exists, the acoustic feedback elimination circuit 26 is configured to perform an acoustic feedback elimination process through the neural network.

In another embodiment, in addition to receiving the second sound signal AI outputted by the second output unit OU2, the first receiving unit RU1 also receives the environmental sound (not shown) of the environment where the first information processing device NB1 is located and transmits the second sound signal AI and the environmental sound (not shown) to the acoustic feedback detection circuit 24 for subsequent processing, but not limited to this.

The second receiving unit RU2 of the second information processing device NB2 is configured to receive the first sound signal AO1 outputted by the first output unit OU1 of the first information processing device NB1 and output the first sound signal AO1 to the second signal feature extraction circuit 28 and a second encoding circuit 29. The second signal feature extraction circuit 28 is configured to receive the first sound signal AO and extract the signal feature SF from the first sound signal AO. The second encoding circuit 29 is configured to receive the first sound signal AO, the signal feature SF and the conference identification code CID respectively and generate the second sound signal AI to the second output unit OU2 according to the first sound signal AO, the signal feature SF and the conference identification code CID. The second output unit OU2 is configured to output the second sound signal AI to the first receiving unit RU1 of the first information processing device NB1.

In another embodiment, the first encoding circuit 22 can also receive a first location information LN1 of the first information processing device NB1 and generate an encoded sound signal AO′ with the first position information LN1 to the acoustic feedback detection circuit 24 according to the first sound signal AO, the signal feature SF, the conference identification code CID and the first position information LN1. The second encoding circuit 29 also receives a second location information LN2 of the second information processing device NB2 and generates the second sound signal AI with the second location information LN2 to the second output unit OU2 according to the first sound signal AO, the signal feature SF, the conference identification code CID and the second location information LN2.

It should be noted that when the acoustic feedback detection circuit 24 detects that the conference identification code CID and the signal feature SF of the second sound signal AI and the encoded sound signal AO′ are the same and knows that the first information processing device NB1 and the second information processing device NB2 are located in the same space according to the first location information LN1 and the second location information LN2, the acoustic feedback detection circuit 24 determines that the acoustic feedback phenomenon exists, and the acoustic feedback elimination circuit 26 performs the acoustic feedback elimination process.

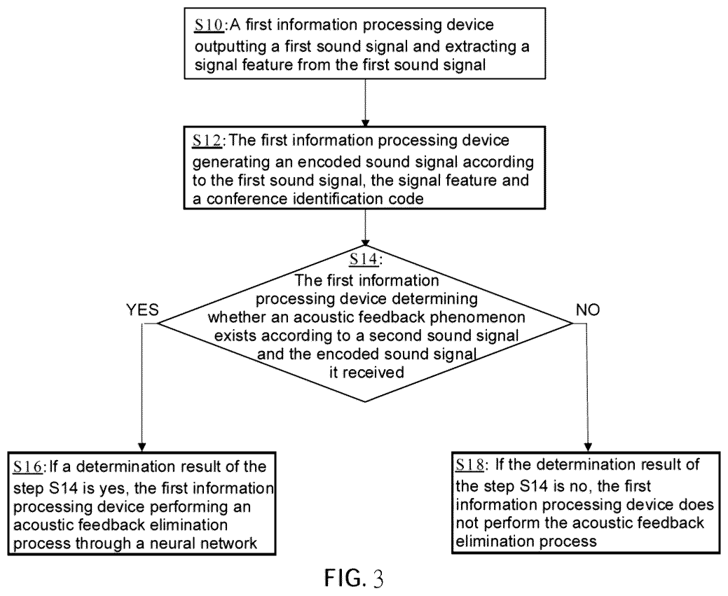

The third preferred embodiment of the invention is an acoustic feedback processing method. In this embodiment, the acoustic feedback processing method is applied to a single information processing device. Please refer to FIG. 3, which illustrates a flowchart of the acoustic feedback processing method in this embodiment. As shown in FIG. 3, the acoustic feedback processing method includes the following steps of:
Step S10: a first information processing device outputting a first sound signal and extracting a signal feature from the first sound signal;
Step S12: the first information processing device generating an encoded sound signal according to the first sound signal, the signal feature and a conference identification code;
Step S14: the first information processing device determining whether an acoustic feedback phenomenon exists according to a second sound signal and the encoded sound signal it received;
Step S16: if a determination result of the step S14 is yes, the first information processing device performing an acoustic feedback elimination process through a neural network; and
Step S18: if the determination result of the step S14 is no, the first information processing device does not perform the acoustic feedback elimination process.

In practical applications, the step S14 is to detect whether the conference identification code and the signal feature of the second sound signal and the encoded sound signal are the same to determine whether the acoustic feedback phenomenon exists. If the step S14 detects that the conference identification code and the signal feature of the second sound signal and the encoded sound signal are the same, it is determined the acoustic feedback phenomenon exists; if the step S14 detects that the conference identification code and the signal feature of the second sound signal and the encoded sound signal are different, it is determined that the acoustic feedback phenomenon does not exist.

In another embodiment, the acoustic feedback processing method is applied to two information processing devices, that is, a first information processing device and a second information processing device. Therefore, in addition to the steps S10˜S18 shown in FIG. 3, the acoustic feedback processing method can also include the following steps of:
the second information processing device receiving the first sound signal outputted by the first information processing device and extracting the signal feature from the first sound signal; and
the second information processing device generating the second sound signal according to the first sound signal, the signal feature and the conference identification code and outputting the second sound signal.

In practical applications, the acoustic feedback processing method can also receive the first position information of the first information processing device and generate the encoded sound signal with the first position information accordingly, and the acoustic feedback processing method can also receive the second position information of the second information processing device and generate the second sound signal having the second position information accordingly.

In another embodiment, when the conference identification code and the signal feature of the second sound signal and the encoded sound signal are the same and it is known that the first information processing device and the second information processing device are located in the same space according to the first location information and the second location information, the step S14 determines that the acoustic feedback phenomenon exists, and the step S16 performs the acoustic feedback elimination process.

In addition, when the first information processing device performs the acoustic feedback elimination process, the acoustic feedback processing method can determine a main target signal and an acoustic feedback signal in the second sound signal through a neural network and automatically align delays between the main target signal and the acoustic feedback signal and suppress and eliminate the acoustic feedback signal to completely retain the main target signal, but not limited to this.

Compared with the prior art, the acoustic feedback processing system and the acoustic feedback processing method of the application can achieve the following effects:
(1) when multiple computer users in the same space participate in the same online conference at the same time, there is no need to turn off the microphone and speakers to prevent howling caused by acoustic feedback;
(2) when multiple players in the same space use the hands-free mode of mobile phones to play games together, all players can still chat without hindrance even if the game sound effects on their mobile phones are turned on at the same time; and
(3) when the user wears the hearing aid, it can prevent the whistling phenomenon caused by acoustic feedback to avoid damage to the user's hearing.

The contents disclosed above are merely feasible embodiments of the invention, and are not intended to limit the scope of the claims of the invention. Therefore, all equivalent technical changes made based on the specification and the drawings of the invention fall within the scope of the claims of the invention.

What is claimed is:

1. An acoustic feedback processing system, comprising:
a first signal feature extraction circuit, configured to extract a signal feature from a first sound signal;
a first encoding circuit, coupled to the first signal feature extraction circuit and configured to receive the first sound signal, the signal feature and a conference identification code and generate an encoded sound signal accordingly;
an acoustic feedback detection circuit, coupled to the first encoding circuit and configured to receive the encoded sound signal and a second sound signal respectively and determine whether acoustic feedback phenomenon exists; and
an acoustic feedback elimination circuit, coupled to the acoustic feedback detection circuit and configured to perform an acoustic feedback elimination process through a neural network in the case of acoustic feedback phenomenon.

2. The acoustic feedback processing system according to claim 1, wherein when the acoustic feedback detection circuit detects that the conference identification code and the signal feature of the second sound signal and the encoded sound signal are the same, the acoustic feedback detection circuit determines that the acoustic feedback phenomenon exists, and the acoustic feedback elimination circuit performs the acoustic feedback elimination process.

3. The acoustic feedback processing system according to claim 1, wherein when the acoustic feedback detection circuit detects that the conference identification code and the signal feature of the second sound signal and the encoded sound signal are different, the acoustic feedback detection circuit determines that the acoustic feedback phenomenon does not exist, and the acoustic feedback elimination circuit does not operate.

4. The acoustic feedback processing system according to claim 1, wherein the acoustic feedback processing system is applied to a first information processing device and the first information processing device comprises:
a first receiving unit, coupled to the acoustic feedback detection circuit and configured to receive the second sound signal and transmit the second sound signal to the acoustic feedback detection circuit; and
a first output unit, coupled to the first signal feature extraction circuit, the first encoding circuit and the acoustic feedback elimination circuit respectively and configured to output the first sound signal.

5. The acoustic feedback processing system according to claim 4, wherein the acoustic feedback processing system is further applied to a second information processing device and the second information processing device comprises:
a second receiving unit, configured to receive the first sound signal outputted by the first output unit; and
a second output unit, configured to output the second sound signal to the first receiving unit.

6. The acoustic feedback processing system according to claim 5, further comprising:
a second signal feature extraction circuit, coupled to the second receiving unit and configured to extract the signal feature from the first sound signal; and
a second encoding circuit, coupled to the second receiving unit, the second output unit and the second signal feature extraction circuit respectively and configured to receive the first sound signal, the signal feature and the conference identification code respectively and generate the second sound signal accordingly to the second output unit.

7. The acoustic feedback processing system according to claim 6, wherein the first encoding circuit also receives a first position information of the first information processing device and generates the encoded sound signal having the first position information accordingly; the second encoding circuit also receives a second position information of the second information processing device and generates the second sound signal having the second position information accordingly.

8. The acoustic feedback processing system according to claim 7, wherein when the acoustic feedback detection circuit detects that the conference identification code and the signal feature of the second sound signal and the encoded sound signal are the same and knows that the first information processing device and the second information processing device are located in the same space, the acoustic feedback detection circuit determines that the acoustic feedback phenomenon exists, and the acoustic feedback elimination circuit performs the acoustic feedback elimination process.

9. The acoustic feedback processing system according to claim 5, wherein the first output unit is a network transmission processing element, the second output unit is a speaker, the first receiving unit is a microphone, and the second receiving unit is a network reception processing element.

10. The acoustic feedback processing system according to claim 1, wherein the first sound signal outputted by the first output unit is transmitted to the second receiving unit through a network.

11. The acoustic feedback processing system according to claim 1, wherein when the acoustic feedback elimination circuit performs the acoustic feedback elimination process, the acoustic feedback elimination circuit determines a main target signal and an acoustic feedback signal in the second sound signal through the neural network, and performs automatic alignment of delays between the main target signal and the acoustic feedback signal and performs suppression and elimination of the acoustic feedback signal to completely retain the main target signal.

12. An acoustic feedback processing method, comprising steps of:
(a) a first information processing device outputting a first sound signal and extracting a signal feature from the first sound signal;
(b) the first information processing device generating an encoded sound signal according to the first sound signal, the signal feature and a conference identification code;
(c) the first information processing device determining whether acoustic feedback phenomenon exists according to a second sound signal and the encoded sound signal it receives; and
(d) if a determination result of step (c) is yes, the first information processing device performing an acoustic feedback elimination process through a neural network.

13. The acoustic feedback processing method according to claim 12, wherein the step (c) is to detect whether the conference identification code and the signal feature of the second sound signal and the encoded sound signal are the same to determine whether the acoustic feedback phenomenon exists.

14. The acoustic feedback processing method according to claim 10, wherein if the step (c) detects that the conference identification code and the signal feature of the second sound signal and the encoded sound signal are the same, it is determined that the acoustic feedback phenomenon exists; if the step (c) detects that the conference identification code and the signal feature of the second sound signal and the encoded sound signal are different, it is determined that the acoustic feedback phenomenon does not exist.

15. The acoustic feedback processing method according to claim 10, further comprising steps of:
(e) a second information processing device receiving the first sound signal outputted by the first information processing device and extracting the signal feature from the first sound signal; and
(f) the second information processing device generating the second sound signal according to the first sound signal, the signal feature and the conference identification code and outputting the second sound signal.

16. The acoustic feedback processing method according to claim 15, wherein the step (b) also receives a first position information of the first information processing device and generates the encoded sound signal having the first position information accordingly; the step (f) also receives a second position information of the second information processing device and generates the second sound signal having the second position information accordingly.

17. The acoustic feedback processing method according to claim 10, further comprising:
when the conference identification code and the signal feature of the second sound signal and the encoded sound signal are the same and it is known that the first information processing device and the second information processing device are located in the same space according to the first location information and the second location information, the step (c) determines that the acoustic feedback phenomenon exists, and the step (d) performs the acoustic feedback elimination process.

18. The acoustic feedback processing method according to claim 10, wherein the first sound signal outputted by the first output unit is transmitted to the second information processing device through a network.

19. The acoustic feedback processing method according to claim 19, wherein when the first information processing device performs the acoustic feedback elimination process, the acoustic feedback processing method also comprises steps of:
determining a main target signal and an acoustic feedback signal in the second sound signal through the neural network; and
performing automatic alignment of delays between the main target signal and the acoustic feedback signal and performing suppression and elimination of the acoustic feedback signal to completely retain the main target signal.
